(19) United States
(12) Patent Application Publication
(10) Pub. No.: US 2006/0023639 A1
(43) Pub. Date: Feb. 2, 2006

(54) System and method for verifying a description of a network

(76) Inventors: Philip L. Bohannon, Bridgewater, NJ (US); Steven Jonathan Fortune, Summit, NJ (US); Clifford E. Martin, Martinsville, NJ (US)

Correspondence Address: Ryan, Mason & Lewis, LLP, 1300 Post Road, Suite 205, Fairfield, CT, 06824, US

(21) Appl. No.: 10/900,561

(22) Filed: Jul. 28, 2004

(51) Int. Cl. H04L 1/00; H04J 1/16; H04J 3/14; H04L 12/26

(52) U.S. Cl. 370/254

(57) ABSTRACT

An apparatus and method are disclosed for verifying that a description of a network corresponds to communication paths of the network. The verification is accomplished by accessing data that represents of a plurality of logical links of the network. A determination is made whether each of the logical links correspond to a communication path of the network. This determination utilizes criteria, which includes: link data; adapter data; and connection data. Thereafter, an indication of whether the logical links correspond to communication paths of the network is provided. If each logical link does not have a corresponding communication path, additional information related to the reason for the non-correspondence may be provided.

### FIELD OF THE INVENTION

This invention relates generally to verifying a description of a network and, more particularly, to confirming that the description of the network is consistent with communication paths of the network.

### BACKGROUND OF THE INVENTION

Networks, such as communication networks, transmit various types of data concurrently, such as text, voice, video and other multimedia files. Communication networks are becoming increasingly complex, especially due to their increasing speeds of operation, the number of interconnected devices and the formation of large networks from sub-networks. Another factor increasing the complexity of communication networks is the layered nature in which a logical link at one technological level is provided as a service by a different technology level. For example, a web browser process might establish a TCP (Transmission Control Protocol) connection to a server process; the connection appears to the two processes as a link. In fact, data sent across the connection traverses an underlying connectionless IP (Internet Protocol) network; a link in the IP network might be provided by a complex hierarchy of connection-oriented ATM (Asynchronous Transfer Mode), SONET (Synchronous Optical Network), and DWDM (Dense Wavelength Division Multiplexing) networks. The layering complexity of networks can only be expected to increase in the future, with the advent of wireless links, virtual private networks and overlaid protocols, such as SIP (Session Initiation Protocol).

Computer tools may be used to design, inventory, analyze, optimize and test networks. These computer tools need a language to describe networks, and fundamental to any such language is a model of network topology, which is a set of links and connections in the network. Conventional computer tools do not permit a uniform network description across multiple levels. Each specific network technology typically has an associated description provided by a standards document; these technology descriptions are usually very detailed and not easily abstracted. Conventional computer tools may use a specific model of network topology; however, the definition of a term in the model of one tool may not match the definition of the same term of another tool. This inconsistency requires a detailed analysis of the semantic model to transfer data between tools.

Thus, conventional approaches do not provide models that can uniformly describe networks across multiple levels. Therefore, it would be an advancement in the art to be able to efficiently confirm that a network is operating according to its specifications.

### SUMMARY OF THE INVENTION

Generally, a method and system are disclosed for verifying a description of a network represented by network map data. Logical links of a network are accessed and a determination is made whether each logical link corresponds to a network communication path. The network communication path is represented by physical link data, connection data, and adapter data.

If the logical links correspond to the communication paths, an affirmative indication is generated. If the logical links do not correspond to the communication paths, a negative indication is generated. These indications can be provided to an output module.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 is a schematic block diagram of the terminal of FIG. 1;

FIG. 3 shows an example of a schematic representation of logical map data and physical map data;

FIG. 4 shows an example of a representation of physical link data;

FIG. 5 shows an example of a representation of adapter data;

FIG. 6 shows an example of a representation of connection data;

FIG. 7 shows an example of a representation of binding data; and

FIGS. 8A-8C show a flowchart of steps for a verification algorithm according to the present invention.

### DETAILED DESCRIPTION

The present invention provides an algorithm to verify a description of the topology of a network. This verification is a pre-condition for many algorithms that manipulate such descriptions, including algorithms that perform network optimization and reorganization, summarize traffic, compute reliability, detect recent changes and analyze alarms. As discussed further below, the topology of the network is described in a language, such as, for example, NetML, which is a language for recording the physical and logical topology of a communications network. NetML is an XML-based language that is applicable across multiple network levels and to a variety of network technologies. Fundamental to NetML is a formal topology model that includes network map data, which is, for example, an abstract computer representation of a network. The network map data includes: physical map data, which represents a set of communication paths; logical map data, which represents a plurality of logical links; and binding data, which represents an association, relationship or correlation between the physical map data and the logical map data.

A verification algorithm, which may use NetML syntax, validates the network map data by establishing that each logical link of the logical map data corresponds to a communication path of the physical map data. The physical map data is analyzed to determine communication paths using physical link data, which is representative of an association of two physical end ports, adapter data, which is representative of adapter type and layer, and connection data, which is representative of an association of two physical ports of a physical link or a physical port of a physical link and a port of an adapter. An indication of whether each of the logical links corresponds to a communication path is provided to an output facility, such as a user interface or display device. If each logical link of the logical map data corresponds to a conductive path, the network map data is consistent, or valid; if not, the network map data is determined to be inconsistent, or invalid, and thus does not accurately represent the network it models.

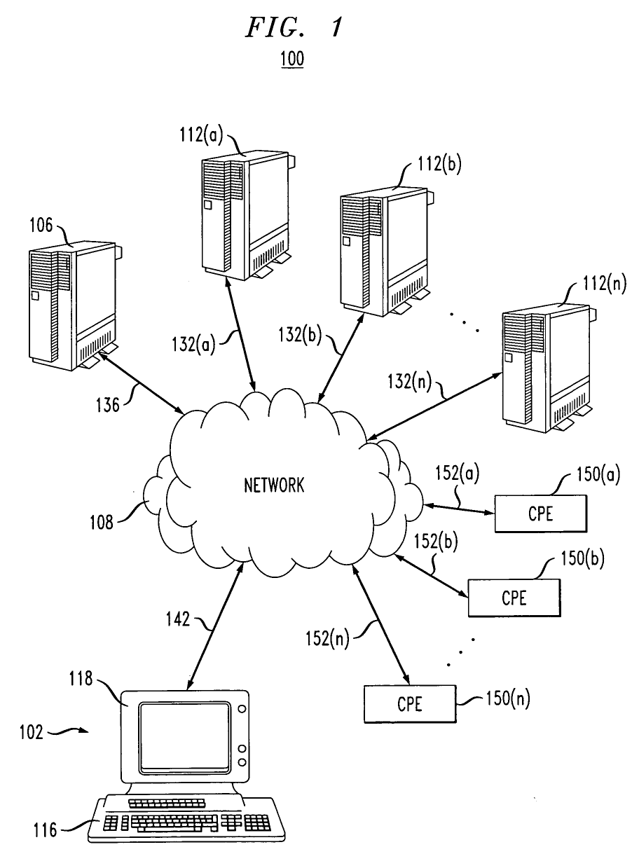

FIG. 1 illustrates a network environment 100 in which the present invention can operate. A user employing a terminal, or workstation 102, accesses remote processing terminals, or facilities, 112(a) through (n) (where n is any suitable number), customer premise equipment (CPE) 150(a) through (n) (where n is any suitable number) and server terminal 106, via a network 108. Network 108 is a network of interconnected terminals or devices. Network 108 may be, for example, a LAN (local area network), a WAN (wide area network), Internet, a PSTN (public switched telephone network), a WLAN (wireless local area network), a PBX (private branch exchange) or combinations thereof, or other interconnection of processing or communication devices.

Server 106 and facilities 112(a) through (n) (generally referred to herein as facilities 112) are typically servers, or other computing devices, with memory and processing capability, coupled to network 108 via associated bi-directional transmission media 136 and 132(a) through (n), respectively. The CPE 150(a) through (n) (generally referred to herein as CPE 150) may be, for example, telephone devices, PBX (private branch exchange) equipment, facsimile machines, scanners, or any other equipment arranged to be connected to network 108, via associated interconnection media 152(a) through (n) (where n is any suitable number) (generally referred to herein as interconnection medium 152). The interconnection medium 152 are, for example, wired or wireless connections. The user may access remote server terminal 106, facilities 112 and CPE 150 using software, such as an applet, operating among the terminal 102, the network 108, and the server terminal 106, facilities 112 and CPE 150.

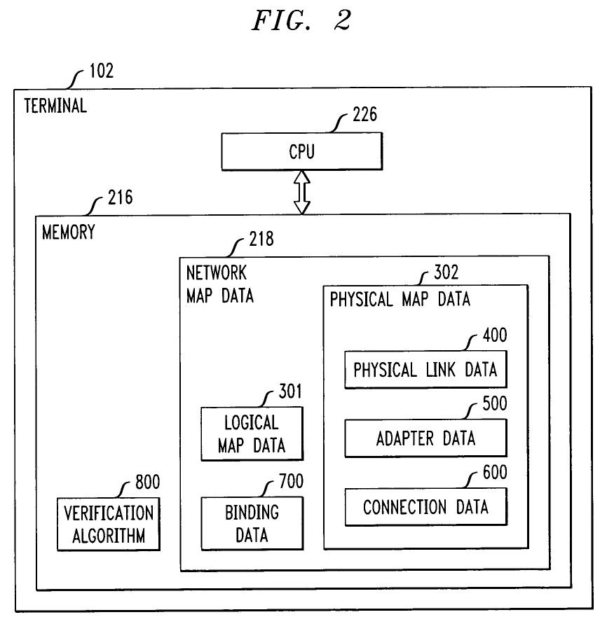

Terminal 102, which is coupled to network 108 via interconnection medium 142, may be, for example, a personal computer (PC), hand-held device (e.g. PDA), or other processing module, as discussed further below in conjunction with FIG. 2. The terminal 102 has adequate memory and adequate processing speed to retrieve network data from remote locations and process, store and output data.

An abstraction, or description of the network topography, also referred to herein as network map data, or a network map, describes network connections, and may be stored at a remote location, such as server terminal 106 and accessed by terminal 102. One way to process the network map data is to download it to terminal 102, process the data and store an indication either at terminal 102 or at a remote location.

The terminal 102 can access a verification algorithm that processes the network map data to determine whether it is valid. For example, FIG. 1 shows connections between network 108 and facilities 112 and CPE 150, which may be a source of the network map data, as well as the network used to provide the environment in which the present invention operates.

FIG. 2 is a schematic block diagram of the terminal 102 shown in FIG. 1. Terminal 102 includes: a central processing unit (CPU) 226; a memory module 216; a display device (shown as element 118 in FIG. 1); input device (shown as element 116 in FIG. 1); and other peripheral devices (not shown). Terminal 102 may be embodied as a commercially available computing system such as a PC or workstation, and may include other conventional components and peripherals that are not shown in FIG. 2.

The processor 226 may be used to access and process the data stored in memory 216.

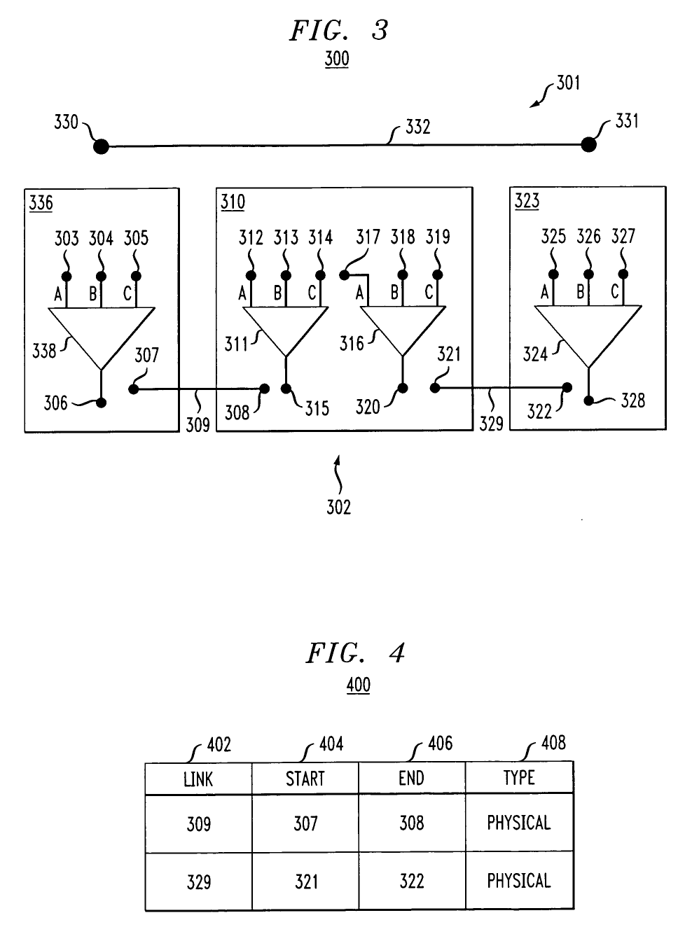

The memory 216 typically includes read only memory (ROM) (not shown), random access memory (RAM) (not shown) and an operating system (not shown). Memory 216 stores the network map data 218 and verification algorithm 800. Network map data 218 includes logical map data 301, physical map data 302 and binding data 700. Physical map data 302 includes physical link data 400, adapter data 500 and connection data 600. The components of memory 216 are discussed below in conjunction with FIGS. 3-8.

While FIG. 2 shows that the verification algorithm 800 is stored as program code in a single location, the verification algorithm 800 may also include sections of code stored in more than one location and accessed as necessary. The memory 216 may also store an output from the verification algorithm 800.

Although only one central processing unit (CPU) 226 is shown in FIG. 2, there may be a plurality of such units, depending on the application.

In order to verify the network map data, it is necessary to describe the network topology. NetML is one language that can be used to describe the topology of a telecommunications network, which includes physical links, logical links, ports and internal cross-connects. NetML is an interchange language that can conform to a particular XML schema. To promote interoperability of tools, NetML is based on a model that is independent of any particular technology and applicable to most common technologies. NetML assigns physical links a type, or layer, which characterizes the format of the data. NetML identifies a link independent of network hierarchy and uniformly incorporates both circuit-switched networks, such as SONET, and packet-switched networks, such as IP and Ethernet, allowing descriptions of communications paths that traverse both packet and circuit switched networks. NetML also provides an XML representation that allows interchange of network descriptions among computer tools.

FIG. 3 shows an example of a schematic representation 300 of logical map data 301 and physical map data 302, which may be generated using NetML, stored in memory and analyzed, processed and manipulated by a processor.

Logical map data 301 shows logical link 332, which is a representation of a communication path from logical link port 330 to logical link port 331. Typically, logical map data 301 includes a plurality of logical links; however, FIG. 3 shows a single logical link 332 for explanation purposes. In order to confirm that the logical link 332 actually corresponds to a communication path between ports 330 and 331, the physical map data 302 and binding data (shown as element 700 in FIG. 2) are analyzed using the verification algorithm (shown as element 800 in FIG. 2).

Physical map data 302 includes physical link data, adapter elements and network elements. These components are discussed in more detail below.

Physical Link Data

Generally, physical link data includes one or more physical links. A physical link represents an ability to transmit data from one place to another and has two ports, one being a start port and the other being an end port.

A physical link is characterized by its layer. A layer is an aggregate set of conventions required to interpret the information flowing on the link as a bit stream. The layer may include, for example, specifications for bandwidth, bit encoding scheme, error correction codes, signaling protocol, framing format and header information.

As shown in FIG. 3, physical link 309 has start port 307 and end port 308. Physical link 329 has start port 321 and end port 322. Data injected into a start port traverses the associated physical link and is ejected at the end port of the link. A physical link is bi-directional, so data injected at either port will be ejected at the other port. Since start port 307 and end port 308 are connected to each other by physical link 309, physical link 309 forms a communication path between start port 307 and end port 308. Similarly, since start port 321 and end port 322 are connected by physical link 329, physical link 329 forms a communication path between those ports.

Physical links and ports may be interpreted concretely, as physical objects. Physical links 309 and 329 could be, for example, copper or fiber cables and ports 307, 308, 321 and 322 could be physical connectors at the end of the cable. Also, physical links 309, 329 could be wireless connections and the ports 307, 308, 321 and 322 could be connectors attached to antenna circuitry.

A further discussion of physical link data is provided in relation to FIG. 4.

Adapter Elements

As shown in FIG. 3, adapter data is generated by analyzing adapter elements 311, 316 324 and 338, also referred to as adapters herein. Adapters perform adaptation, or conversion between layers of a network. Adaptation represents both encapsulation, the encoding of one data stream with another, for example, by adding extra header information, and multiplexing, where several data streams are combined into a single stream. Each adapter has an indexed set of guest ports (user ports) and an indexed set of host ports (provider ports). For example, adapter 338 has guest ports 303, 304 and 305. Guest port 303 has a label A, guest port 304 has a label B and guest port 305 has a label C. Adapter 311 has guest ports 312, 313 and 314, with labels A, B and C, respectively. Adapter 316 has guest ports 317, 318 and 319 with labels A, B and C, respectively. Adapter 324 has guest ports 325, 326 and 327 with labels A, B and C, respectively. Adapters 302, 311, 316 and 324 have host ports 306, 315, 320 and 328, respectively.

The adapter elements are configured to perform adaptation or conversion between layers of a network. Each adapter has an associated adapter type. The adapter type determines the layer and label of a host port and a sequence of layers and labels for guest ports. An adapter is labeled with its type, and the layers and labels of its ports must agree with the corresponding layers and labels in the type for the adapter to perform adaptation operations.

For example, an adapter that has a single guest port and a single host port causes any data stream of the appropriate layer to be injected into the guest port where it is adapted (converted) to the layer of the host port and then ejected. An adapter that has several guest ports and a single host port causes the data streams injected into the guest ports to be multiplexed together and ejected from the host port. Adapters are bi-directional, so they can be used to convert data back from the host layer to the guest layer or layers.

A communication path can be established by injecting data into a guest port of an adapter, the adapted data is ejected from the host port, traverses a link (or, more generally, another communication path) to another adapter host port, where it is then de-multiplexed, or “unadapted,” and ejected from the guest port with the same label as the first guest port. The adapter types and guest port labels and layers must match in order to establish a communication path. The adapter type determines the layer of a host port and a sequence of layers for guest ports. An adapter is labeled with its type and the layers of its ports must agree with the corresponding layers in the type.

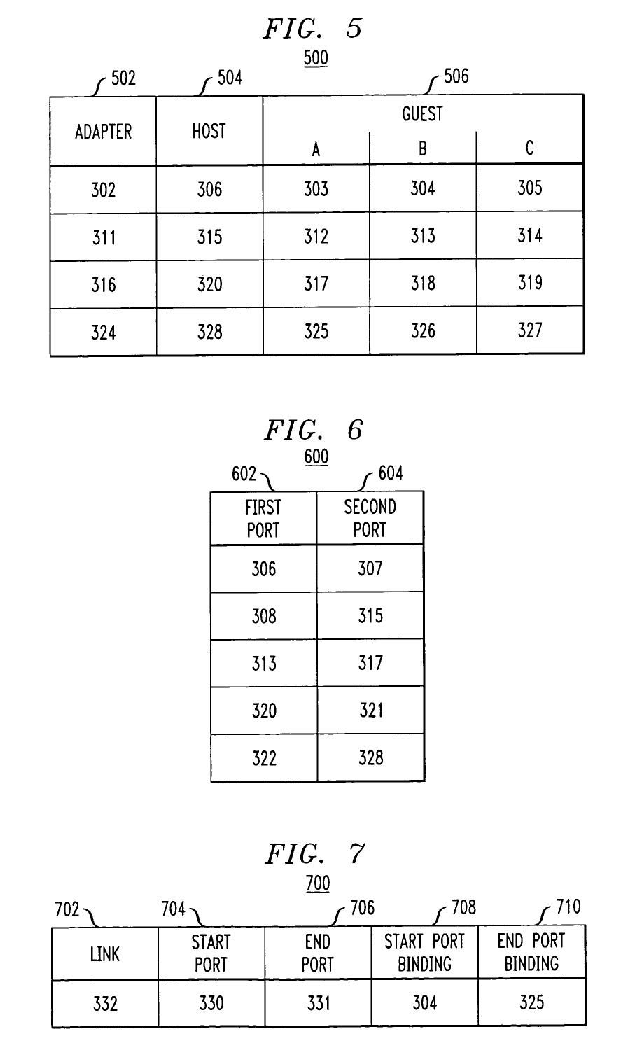

A further discussion of adapter data is provided in relation to FIG. 5.

Network Elements (Connection Data)

Network elements, 310 323 and 336, also referred to as nodes herein, show that connection data can be generated by compiling, or combining, a plurality of links and associated ports, and/or portions of a plurality of links and associated ports, together. Examples of connection data representing a communication path are: port 306 and port 307; port 308 and port 315; port 320 and port 321; and port 322 and port 328.

A further discussion of connection data is provided in relation to FIG. 6.

The physical map data 302, which may be represented as NetML, may include a plurality of network layers, such as, for example, SONET, SDH (Synchronous Digital Hierarchy), IP and ATM. As discussed above, a link or port is characterized by its layer, which is the relevant set of information required to characterize the data flowing on a link. The layer may include specifications for bandwidth, bit encoding scheme, error correcting codes, signaling protocol, framing format, header information or other information and may be viewed as an aggregate.

For example, a sequence of adaptations allows a layered interpretation of the data actually transferred over a plurality of physical links. Data at a first port may be IP; at a second port the data can be interpreted as IP over ATM; and at a third port, the data can be interpreted as IP over ATM over SONET. The data at a fourth port can be interpreted as the direct encapsulation of IP over SONET.

FIG. 4 shows an example of a representation of physical link data 400, which is a component of the physical map data (shown in FIG. 3 as 302). The representation of physical link data 400 is typically an abstraction of the physical link data, described in relation to FIG. 3, and represented in a form that can be stored in memory and analyzed, processed and manipulated by a processor, as described herein. The physical link data 400 is, for example, a data structure or matrix that has a field 402 that identifies each of a plurality of physical links, a field 404 that identifies a start port for each physical link, a field 406 that identifies an end port for each physical link and a field 408 that identifies links 309 and 329 as physical links.

While the example of FIG. 4 shows that field 402 identifies two physical links (309 and 329), it should be understood that the number of physical links is a function of the physical map data.

As shown in FIG. 4, physical link 309 (field 402) has start port 307 (field 404), end port 308 (field 406). Physical link 309 is a physical link (field 408) because start port 307 is connected to end port 308.

FIG. 4 also shows that physical link 329 (field 402) has start port 321 (field 404) and end port 322 (field 406).

FIG. 5 shows an example of a representation of adapter data 500, which is a component of the physical map data (shown in FIG. 3 as 302). The representation of adapter data 500 is typically an abstraction of the adapter data, described in relation to FIG. 3, and represented in a form that can be stored in memory and analyzed, processed and manipulated by a processor, as described herein. The adapter data 500 is, for example, a data structure or matrix that has a field 502 that stores adapter identification data, a field 504 that stores host port data and a field 506 that stores guest port data, in three sub-fields, A, B and C, that identify a label of the particular guest port.

As shown in FIG. 5, adapter 302 (field 502) has a host port 306 (field 504) and three guest ports, 303, 304 and 305 (field 506). Guest port 303 has label A, guest port 304 has label B and guest port 305 has label C. Similarly, adapter 311 has a host port 315 and guest ports 312, 313 and 314, having labels A, B and C, respectively. Adapter 316 has host port 320 and guest ports 317, 318 and 319, having labels A, B and C, respectively. Finally, adapter 324 has host port 328 and guest ports 325, 326 and 327, having labels A, B and C, respectively.

FIG. 6 shows an example of a representation of connection data 600, which is a component of the physical map data (shown in FIG. 3 as 302). Connection data 600 represents an association of two physical ports of a physical link or a port of a physical link and a port of an adapter. A port may be connected to another port at the same layer and data ejected from one port is injected into a connected port. The representation of the connection data 600 is typically an abstraction of the connection data, described in relation to FIG. 3, and represented in a form that can be stored in memory and analyzed, processed and manipulated by a processor, as described herein. The connection data 600 is, for example, a data structure or matrix that has a field 602 that stores first port data and field 604 that stores second port data. As shown in FIG. 6, port 306 is connected to port 307. Similarly, ports 308 and 315 are connected, ports 313 and 317 are connected, ports 320 and 321 are connected and ports 322 and 328 are connected. This connection data 600 is used to determine communication paths of the physical map data (shown in FIG. 3 as 302).

FIG. 7 shows an example of a representation of binding data 700, which is a component of the network map data (shown in FIG. 2 as 218). Binding data 700 is an association between the physical map data (shown in FIG. 3 as 302) and the logical map data (shown in FIG. 3 as 301). The representation of the binding data 700 is typically an abstraction of the binding data represented in a form that can be stored in memory and analyzed, processed and manipulated by a processor, as described herein. The binding data 700 is, for example, a data structure or matrix that has a field 702 that identifies link 332, start port field 704, end port field 706, start port binding field 708 and end port binding field 710. The binding data associates start port 330 (field 704) of logical link 332 to port 304 (field 708) and end port 331 (field 706) to port 325 (field 710). Therefore, in order to establish a communication path corresponding to logical link 332, the physical map data (shown in FIG. 3 as 302) is analyzed using a verification algorithm to verify that a path exists between port 304, which is bound to port 330, and port 325, which is bound to port 331.

Binding data 700 shows that ports 330 and 304 and ports 331 and 325, respectively, are bound. As shown in FIG. 3, data injected into guest port 304, having label B, is multiplexed, via adapter 302, with other data streams that are injected at guest ports 303 and 305 and ejected from host port 306. Host port 306 and start port 307 are connected, as a result of connection data 600, shown in FIG. 6, and the data ejected from host port 306 is injected into start port 307, traverses physical link 309, and is ejected from end port 308. End port 308 and end port 315 are connected, as a result of connection data 600, shown in FIG. 6, and the data is injected into host port 315, where it is reverse multiplexed, or “unadapted,” by adapter 311 and ejected from guest port 313 (the label B of port 313 matches the label B of port 304). The connection data 600, shown in FIG. 6, shows guest ports 313 and 317 are connected and the data is injected into guest port 317.

Data from port 317 is multiplexed by adapter 316 and ejected from host port 320. Connection data 600, shown in FIG. 6, shows that host port 320 is connected to start port 321. The data traverses physical link 329 and is ejected from end port 322. The connection data 600, shown in FIG. 6, shows that end port 322 is connected to host port 328. The data is reverse multiplexed, or “unadapted” by adapter 324 and ejected from guest port 325. The binding data shows that guest port 325 is associated with port 331 of logical link 332. Hence, logical link 332 is valid since it has a corresponding communication path through physical map data 302.

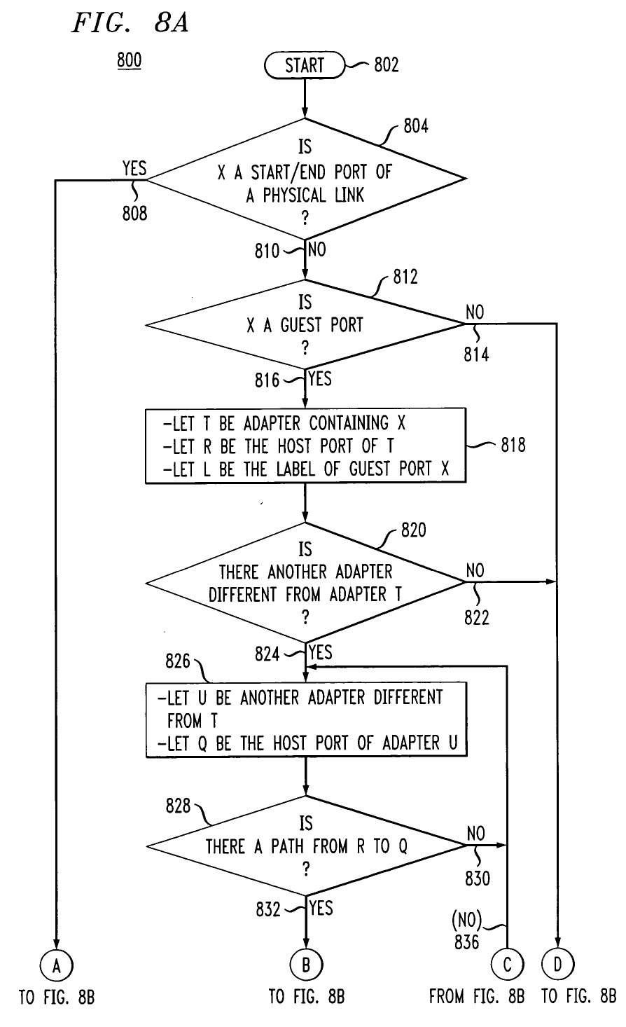

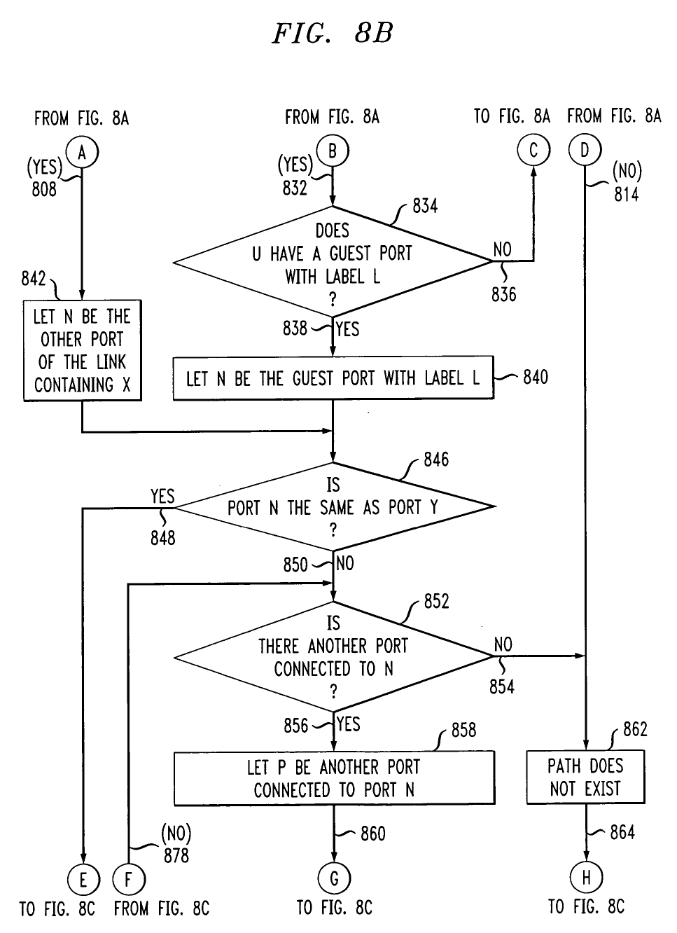

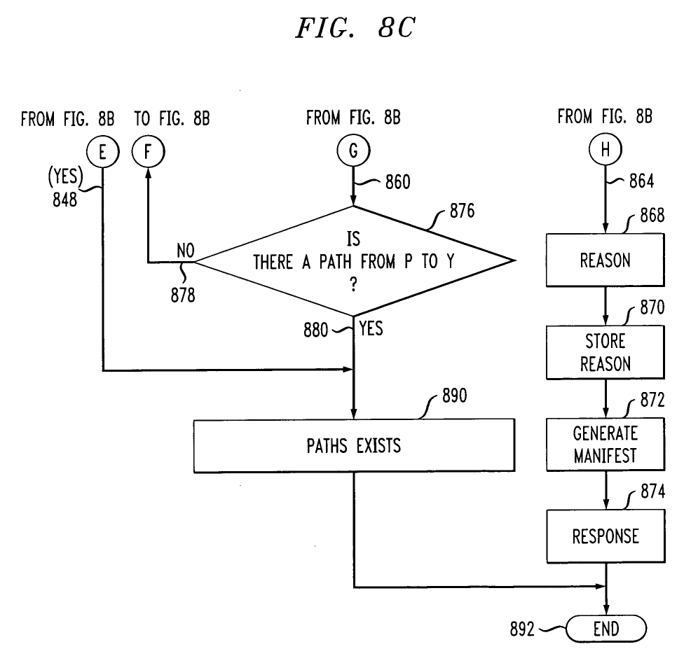

FIGS. 8A-8C, generally referred to herein as FIG. 8, are a flowchart of exemplary steps for a verification algorithm 800. These steps, or functional features, are shown as blocks and are suitably stored on a computer-readable medium, which can be read by a computer, or other processing device, as described herein. The steps may be program code or a series of manipulations of data. While FIG. 8 shows steps in a particular sequence, this is for explanation purposes, and it is within the scope of the invention that the specific sequence may be modified as a function of specific applications, program code and design considerations.

Generally, verification algorithm 800, which is described using examples used in FIGS. 2-7, shows steps to verify that the logical links of logical map data (shown in FIG. 3 as 301) correspond to communication paths of the network using the physical map data (shown in FIG. 3 as 302). The algorithm may function in a parallel processing environment wherein criteria are being analyzed substantially simultaneously or in a serial processing environment, in which the analysis is performed substantially sequentially. While FIG. 8 shows an example of validating a single logical link it should be apparent to one skilled in the art that the algorithm can be used to verify a plurality of logical links.

A communication path between two ports X (304 of FIG. 3) and Y (325 of FIG. 3) exists if: the two ports are the start and end ports of a link; or if ports X and Y are each guest ports of an adapter with identical labels, and there is a communication path between the host ports of the two adapters; or there are two intermediate connected ports, with a communication path from port X to one of the intermediate ports, and from another intermediate port to port Y.

Step 802 begins the algorithm for verifying whether there is a communication path from a port X (304 of FIG. 3) to a port Y (325 of FIG. 3), which may be the start and end ports of physical map data that are bound to start and end ports of a logical link to be verified (link 332 of FIG. 3). The physical map data (302 of FIG. 2) includes ports, indicated as N, P, Q, R and S, (examples of ports are provided in FIG. 3 as elements 303, 304, 305, 306, 307, 308, 312, 313, 314, 315 316, etc.) and adapters T and U (examples of adapters are provided in FIG. 3 as elements 338, 311, 316 and 324). Step 804 determines whether X (port 304 of FIG. 3) is a start port or end port of a physical link. If so, “yes” line 808 leads to step 842. Step 842 sets port N to be the other port of the physical link containing port X (port 304 of FIG. 3). Step 846 determines if port N is the same port as port Y (port 325 of FIG. 3). If so, “yes” line 848 leads to step 890. Step 890 establishes that the logical link with link ports that are bound to ports X (port 304 of FIG. 3) and Y (port 325 of FIG. 3) corresponds to a communication path of the physical map data and the particular logical link is valid.

If step 846 determines that port N is not port Y (port 325 of FIG. 3), then “no” line 850 leads to step 852. Step 852 determines whether another port is connected to port N. If so, “yes” line 856 leads to step 858, which establishes P as the other port connected to port N. Line 860 leads to decision block 876, which determines whether there is a path from port P to port Y (port 325 of FIG. 3). If so, “yes” line 880 leads to step 890, which determines that a path exists. If not, “no” line 878 leads back to decision step 852.

If decision step 852 determines that there is not another port connected to port N, “no” line 854 leads to step 862, which determines that a path does not exist, and the logical link does not correspond to a communication path and, therefore, the network data is not valid. Line 864 leads to step 868, which establishes a reason for the invalidity. The reason generated may identify one or more logical links that do not correspond to a communication path. This reason can identify whether the failure was attributed to link data, connection data, adapter data or a combination thereof. The step of generating a reason is optional and can be omitted.

Step 870 stores reasons for the failure. Step 872 generates an accumulation of invalid logical links, such as a manifest, or record. This manifest may include the reasons for the invalidity. As a further embodiment, the manifest can optionally be transmitted to an output module or facility.

Step 874 generates a response, or negative indication, or alert, reflecting the inconsistency. This negative indication may be output to a user device, or display device or may be stored in a remote or local memory. End step 892 ends the algorithm.

Returning to step 804, if port X (port 304 of FIG. 3) is not a start port or an end port, “no” line 810 leads to decision step 812, which determines whether X (port 304 of FIG. 3) is a guest port. If not, “no” line 814 leads to leads to step 862, which indicates that there is not a communication path from port X (port 304 of FIG. 3) to port Y (port 325 of FIG. 3). If decision block 812 determines that port X (port 304 of FIG. 3) is a guest port, “yes” line 816 leads to step 818. Step 818 establishes: T (adapter 338 of FIG. 3) to be an adapter containing port X (port 304 of FIG. 3); R (port 306 of FIG. 3) is the host port of adapter T (adapter 338 of FIG. 3); and L (label B of FIG. 3) is the label of guest port X (port 304 of FIG. 3). Decision step 820 determines whether there is another adapter different than adapter T (adapter 338 of FIG. 3). If not, “no” line 822 leads to line 814, discussed above. If decision step 820 determines that there is another adapter different from adapter T, “yes” line 824 leads to step 826. Step 826 establishes: U (adapter 311 of FIG. 3) as another adapter different from adapter T; and Q (port 315 of FIG. 3) as the host port of adapter U (adapter 311 of FIG. 3). Decision block 828 determines whether there is a path from host port R (port 306 of FIG. 3) to host port Q (port 315 of FIG. 3) of adapter U (adapter 311 of FIG. 3). If not, “no” line 830 leads to step 826. If so, “yes” line 832 leads to decision block 834, which determines whether adapter U (adapter 311 of FIG. 3) has a guest port (port 313 of FIG. 3) with label L. If not, “no” line 836 leads to step 826. If so, “yes” line 838 leads to step 840, which establishes N as the guest port (port 313 of FIG. 3) with label L. Step 846, discussed previously, is reached from step 840.

When all of the logical links of a logical map have been validated, or verified, by establishing that each logical link represents a communication path, a match indication is generated. This affirmative indication may be output to a user device, or display device or may be stored in a remote or local memory. If each of the logical links is not valid, the network map data is not valid.

While FIG. 8 shows an example of the sequence of steps, it is also an embodiment of the present invention that the sequence may be varied. Various permutations of the algorithm are contemplated as alternate embodiments of the invention.

As described above, layers and adapter types can be discriminated in the network and these layers and types may be preserved during the manipulations of the present invention.

It is also a further embodiment of the present invention that the verification algorithm determines a communication path corresponding link as efficiently as possible. For example, as soon as a logical link is verified, processing terminates for that logical link.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

It is to be understood that the invention may be practiced with other computer system configurations, including, for example, hand-held devices, multiprocessor systems, microprocessor-based or programmable consumer electronic devices, network PC's, minicomputers, mainframe computers, and other devices with processing capabilities. The embodiment may also be practiced in distributed computing environments where tasks are performed by remote processing devices that are linked through a communications network. In a distributed computing environment, program modules may be located in both local and remote memory storage devices.

It is to be understood that the embodiments and variations shown and described herein are merely illustrative of the principles of this invention and that various modifications may be implemented by those skilled in the art without departing from the scope and spirit of the invention.

We claim:

1. A method for verifying a representation of a network, comprising the steps of:
accessing one or more logical links of the network;
accessing communication path data representative of transmission linking, port multiplexing and port connections of the network; and
determining whether each of the one or more logical links corresponds to a communication path based on the communication path data.

2. The method of claim 1, wherein the determining step further comprises the step of associating ports of each logical link to portions of physical map data.

3. The method of claim 1, further comprising the steps of:
identifying link port data for one or more physical links; and
utilizing the link port data in the determining step.

4. The method of claim 1, further comprising the steps of:
identifying an adapter port status for one or more adapter ports; and
utilizing the adapter port status in the determining step.

5. The method of claim 1, further comprising the steps of:
identifying an adapter port label for one or more adapter ports; and
utilizing the adapter port label in the determining step.

6. The method of claim 1, further comprising the steps of:
identifying connections between physical links;
identifying connections between adapter ports; and
utilizing the connections between physical links and the connections between adapter ports in the determining step.

7. The method of claim 1, further comprising the step of terminating the determining step for a particular logical link once the particular logical link is determined to correspond to a communication path.

8. A method for verifying a representation of a network, comprising the steps of:
accessing one or more logical links of the network; and
determining whether each of the one or more logical links corresponds to a network communication path represented by physical link data, connection data, and adapter data.

9. The method of claim 8, wherein the determining step further comprises the step of associating ports of each logical link to portions of physical map data.

10. The method of claim 8, further comprising the steps of:
identifying link port data for one or more physical links; and
utilizing the link port data in the determining step.

11. The method of claim 8, further comprising the steps of:
identifying an adapter port status for one or more adapter ports; and
utilizing the adapter port status in the determining step.

12. The method of claim 8, further comprising the steps of:
identifying an adapter port label for one or more adapter ports; and
utilizing the adapter port label in the determining step.

13. The method of claim 8, further comprising the steps of:
identifying connections between physical links;
identifying connections between adapter ports; and
utilizing the connections between physical links and the connections between adapter ports in the determining step.

14. The method of claim 8, further comprising the steps of:
identifying one or more layers of the network; and
preserving the one or more layers of the network during the determining step.

15. The method of claim 8, further comprising the steps of:
identifying one or more adapter types of the network; and
preserving the one or more adapter types during the determining step.

16. The method of claim 8, further comprising the step of terminating the determining step for a particular logical link once the particular logical link is determined to correspond to a network communication path.

17. The method of claim 8, wherein the representation of the network comprises an abstraction of the network.

18. The method of claim 8, wherein the representation of the network is generated by a NetML tool.

19. The method of claim 8, further comprising the step of generating an alert signal when the determining step determines that one of the logical links does not correspond to a network communication path.

20. A method for verifying a representation of a network, comprising the steps of:
accessing logical map data that represents one or more logical links of the network;
accessing physical map data that represents one or more communication paths;
associating a first portion of a selected logical link with a first port of the physical map data;
associating a second portion of the selected logical link with a second port of the physical map data;
identifying links between the first port and the second port;
identifying connections among the links;
identifying a first adapter containing the first port;
identifying one or more additional adapters containing adapter ports;
identifying connections among the adapters; and
determining whether the selected logical link corresponds to a communication path from the first port to the second port as a function of the identifying steps.

21. The method of claim 20, wherein the step of identifying one or more additional adapters containing adapter ports further comprises the steps of:
identifying a status indicator for each of the adapter ports; and
utilizing the status indicator in the determining step.

22. The method of claim 20, wherein the step of identifying one or more additional adapters containing adapter ports further comprises the steps of:
identifying a label for each of the adapter ports; and
utilizing the label in the determining step.

23. A system for verifying a representation of a network, comprising:
a memory; and
at least one processor, coupled to the memory, operative to:
access one or more logical links of the network;
access communication path data representative of transmission linking, port multiplexing and port connections of the network; and
determine whether each of the one or more logical links corresponds to a communication path based on the communication path data.

24. The system of claim 23, wherein the processor is further operative to associate ports of each logical link to portions of physical map data.

25. The system of claim 23, wherein the processor is further operative to:
identify link port data for one or more physical links; and
utilize the link port data to determine whether each of the one or more logical links corresponds to a communication path.

26. The system of claim 23, wherein the processor is further operative to:
identify an adapter port status for one or more adapter ports; and
utilize the adapter port status to determine whether each of the one or more logical links corresponds to a communication path.

27. The system of claim 23, wherein the processor is further operative to:
identify an adapter port label for the one or more adapter ports; and
utilize the adapter port label to determine whether each of the one or more logical links corresponds to a communication path.

28. The system of claim 23, wherein the processor is further operative to:
identify connections between physical links;
identify connections between adapter ports; and
utilize the connections between physical links and the connections between adapter ports to determine whether each of the one or more logical links corresponds to a communication path.

29. The system of claim 23, wherein the processor is further operative to terminate processing once a particular logical link is determined to correspond to a communication path.

30. A system for verifying a representation of a network, comprising:
a memory; and
at least one processor, coupled to the memory, operative to:
access one or more logical links of the network; and
determine whether each of the one or more logical links corresponds to a network communication path represented by physical link data, connection data, and adapter data.

31. The system of claim 30, wherein the processor is further operative to:
identify connections between physical links;
identify connections between adapter ports; and
utilize the connections between physical links and the connections between adapter ports to determine whether each of the one or more logical links corresponds to a network communication path.

32. An article of manufacture for verifying a representation of a network, comprising a machine readable medium containing one or more programs that when executed implement the steps of:
accessing one or more logical links of the network;
accessing communication path data representative of transmission linking, port multiplexing and port connections of the network; and
determining whether each of the one or more logical links corresponds to a communication path based on the communication path data.
